(19) United States
(12) Patent Application Publication
(10) Pub. No.: US 2011/0219418 A1
(43) Pub. Date: Sep. 8, 2011

(54) WIDEBAND CABLE MODEM AND CHANNEL LOCKING METHOD

(75) Inventor: CHI-FU KOH, Tu-Cheng (TW)

(73) Assignee: HON HAI PRECISION INDUSTRY CO., LTD., Tu-Cheng (TW)

(21) Appl. No.: 12/732,204

(22) Filed: Mar. 26, 2010

(30) Foreign Application Priority Data
Mar. 4, 2010 (CN) 201010117905.9

(51) Int. Cl. H04N 7/173

(52) U.S. Cl. 725/111

(57) ABSTRACT

A wideband cable modem includes a plurality of tuners and a plurality of central frequencies each corresponding to one of a plurality of frequency ranges. Each frequency range is divided into a plurality of frequency segments. A scan controlling thread of the wideband cable modem retrieves one of the central frequencies corresponding to one of the frequency ranges, and controls a plurality of channel locking threads to synchronously scan the plurality of frequency segments of the corresponding frequency range to lock onto a downstream channel according to the retrieved central frequency. Each of the channel locking threads of the wideband cable modem controls one of the tuners to scan one of the frequency segments to lock onto a downstream channel.

### BACKGROUND

1. Technical Field

Embodiments of the present disclosure relate to cable modems, and more particularly to a wideband cable modem and a channel locking method.

2. Description of Related Art

Generally, frequency plan of a cable modem is from 93 MHz to 999 MHz, and a 6 MHz channel is retrieved from the frequency plan to downstream data. The first step of cable modem provisioning is to scan a frequency range of the frequency plan to lock onto the downstream channel.

However, because the frequency of the downstream channel is initially unknown, the cable modem should scan frequencies through the frequency range of the frequency plan one by one, such as scanning frequencies from 93 MHz to 999 MHz every 6 MHz, namely 93 MHz, 99 MHz, 105 MHz, . . . , 993 MHz, and 999 MHz. As a result, the cable modem requires much time to lock onto the downstream channel. Therefore, a system to resolve this weakness is desired.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a wideband cable modem of the present disclosure;

FIG. 2 is a schematic diagram of a central frequency list generating method of FIG. 1;

FIG. 3 is a schematic diagram of communication between a scan controlling thread and a locking thread group of FIG. 1;

FIG. 4 is a flowchart of one embodiment of a channel locking method processed by a scan controlling thread of FIG. 1 or FIG. 3; and

FIG. 5 is a flowchart of one embodiment of a channel locking method processed by channel locking threads of FIG. 1 or FIG. 3.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

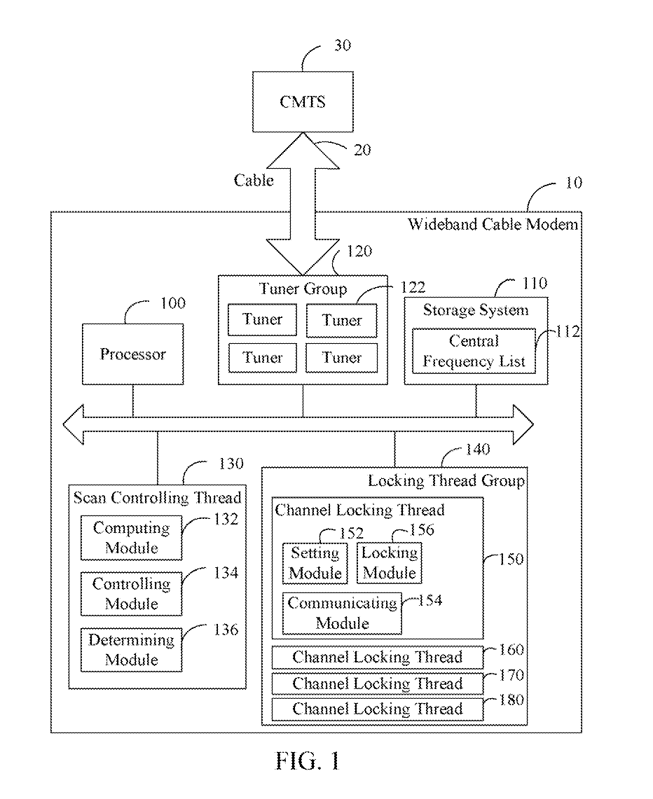

FIG. 1 is a schematic diagram of an application environment and functional modules of one embodiment of a wideband cable modem 10 of the present disclosure. The wideband cable modem 10 is connected to a cable modem termination system (CMTS) 30 by a cable 20.

In one embodiment, the wideband cable modem 10 includes a processor 100, a storage system 110, and a tuner group 120. The tuner group 120 includes a plurality of tuners 122, such as four tuners, or eight tuners, although only four are shown in FIG. 1 for simplicity. In one embodiment, the tuner group 120 may be four integrated narrowband tuners. In other embodiments, the tuner group 120 may be a wideband tuning chipset that includes four narrowband tuners, such as an MT2170 produced by MICROTUNER.

The storage system 110 stores a central frequency list 112 that lists a plurality of central frequencies of the wideband cable modem 10. The central frequency list 112 is preset according to the frequency plan of the wideband cable modem 10. The frequency plan of the wideband cable modem 10 is divided into one or more frequency ranges. Each central frequency corresponds to one frequency range of the frequency plan of the wideband cable modem 10. The wideband cable modem 10 will scan frequencies of the frequency plan in every frequency range. Therefore, when the wideband cable modem 10 can lock onto a downstream channel of the wideband cable modem 10 in the first frequency range, scanning the remaining frequency ranges is not required.

Each frequency range is divided into a plurality of frequency segments. The wideband cable modem 10 will scan each frequency range segment by segment using the plurality of tuners 122. Thus, four frequency segments can be scanned at one time with the employment of the four tuners 122, resulting in the wideband cable modem 10 cutting scan time by as much as 75%.

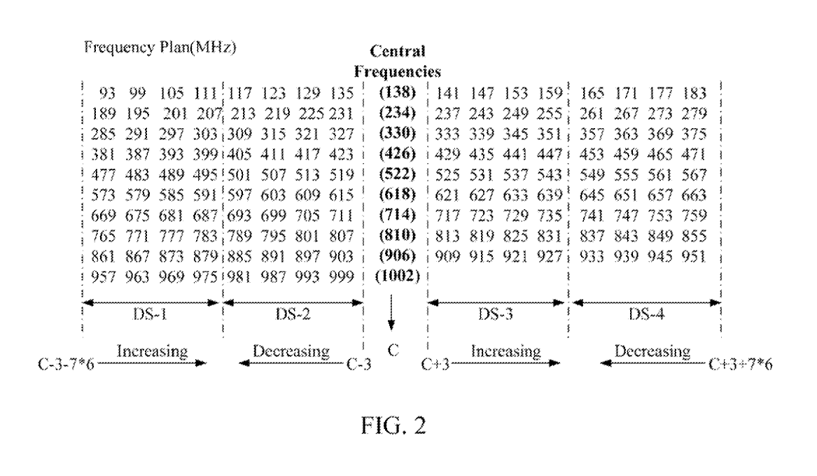

FIG. 2 is a schematic diagram of a method for generating the central frequency list 112 of FIG. 1. The wideband cable modem 10 may have several types of frequency plans, such as from 93 MHz to 999 MHz with 6 MHz jumps for 152 frequencies, or from 93 MHz to 999 MHz with 250 kHz offset for 3424 frequencies. FIG. 2 employs the first example to describe how to generate the central frequency list 112, but the disclosure is not limited thereto.

The frequency plan 93 MHz to 999 MHz can be divided into 10 frequency ranges, each of the 10 frequency ranges including 16 frequencies except for the last frequency ranges, which will have only the last 8 frequencies. Each frequency range of the frequency plan includes a maximum frequency and a minimum frequency. An average of the maximum frequency and the minimum frequency of each frequency range is equal to the corresponding central frequency.

For example, a central frequency of a first frequency range from 93 MHz to 183 MHz is an average of 93 MHz and 183 MHz, namely 138 MHz. According to this example, other central frequencies of other frequency ranges can be respectively computed. All the central frequencies are listed in sequence to generate the central frequency list 112. In other embodiments, the frequency plan may also be divided into 1 frequency range, 5 frequency ranges, 20 frequency ranges as needed. In the preferred embodiment, each frequency range of the frequency plan includes a special number of frequencies, and the special number is a multiple of the number of tuners 122, such as 8, or 32.

Each frequency range of the frequency plan includes a number of frequency segments equal to the number of tuners 122. In this case there are four frequency segments DS-1, DS-2, DS-3, and DS-4, one distributed to each tuner 122 respectively. Each frequency segment includes a start frequency and a scanning direction, which are computed according to the central frequency (C for short) of the corresponding frequency range. Each tuner 122 scans each frequency segments according to the corresponding start frequency and the scanning direction. The start frequencies and the scanning directions of each frequency range can be computed by any one of known methods, so long as each of the four tuners 122 can scan one fourth of the frequencies of the frequency range according to the start frequencies and the scanning directions.

For example, each frequency range includes 16 frequencies from C−3−(7*6) to C+3+(7*6) in 6 MHz increments. The start frequency of the frequency segment DS-1 equals C−3−(7*6), and the scanning direction thereof is “increasing” indicating scanning from that frequency up. That is, a first tuner 122 scans the frequency segment DS-1 from the frequency C−3−(7*6), then C−3−(6*6), then C−3−(5*6), and then C−3−(4*6). The start frequency of the frequency segment DS-2 equals C−3, and the scanning direction thereof is “decreasing” indicating scanning from that frequency down. That is, a second tuner 122 scans the frequency segment DS-2 from the frequency C−3, then C−3−6, then C−3−(2*6), and then C−3−(3*6). The start frequency of the frequency segment DS-3 equals C+3, and the scanning direction thereof is “increasing”. That is, a third tuner 122 scans the frequency segment DS-3 from the frequency C+3, then C+3+6, then C+3+(2*6), and then C+3+(3*6). The start frequency of the frequency segment DS-4 equals C+3+(7*6), and the scanning direction thereof is “decreasing”. That is, a fourth tuner 122 scans the frequency segment DS-4 from the frequency C+3+(7*6), then C+3+(6*6), then C+3+(5*6), and then C+3+(4*6). Therefore, each of the four tuners 122 can scan one fourth of the frequencies of one frequency range employing one fourth of the time cost.

In other embodiments, the start frequency and the scanning direction of each frequency segment may be computed according to other formulas. For example, the start frequency of the frequency segment DS-1 equals C−3−(4*6), and the scanning direction thereof is “decreasing”. The start frequency of the frequency segment DS-2 equals C−3−(3*6), and the scanning direction thereof is “increasing”. The start frequency of the frequency segment DS-3 equals C+3+(3*6), and the scanning direction thereof is “decreasing”. The start frequency of the frequency segment DS-4 equals C+3+(4*6), and the scanning direction thereof is “increasing”. In this example, the four tuners 122 also work together to scan frequency ranges and can save up to 75% of the time it would take by employing only one scanner.

Referring again to FIG. 1, the processor 100 establishes a scan controlling thread 130 and a locking thread group 140. The locking thread group 140 includes a plurality of channel locking threads. The number of the channel locking threads may be 4 or 8 and corresponds with that of the tuners 122, although only four are shown in FIG. 1 for simplicity, namely the channel locking threads 150, 160, 170, 180. Here, a thread is a sequence of instructions that may execute in parallel with other threads.

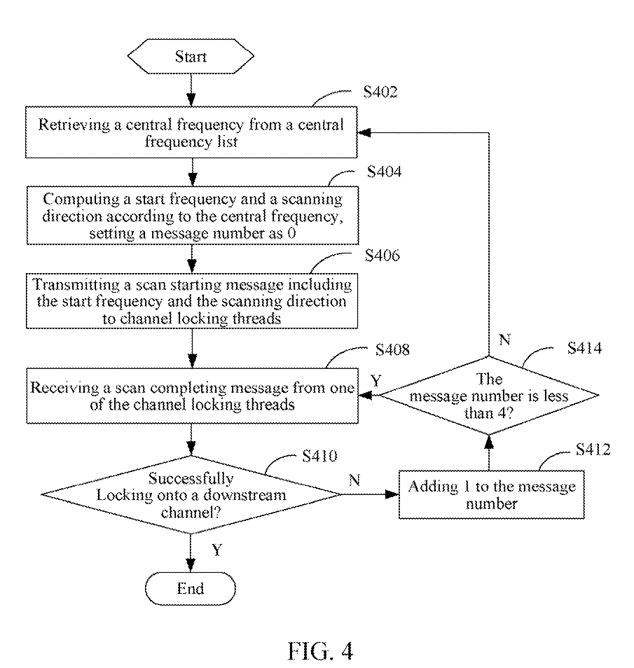

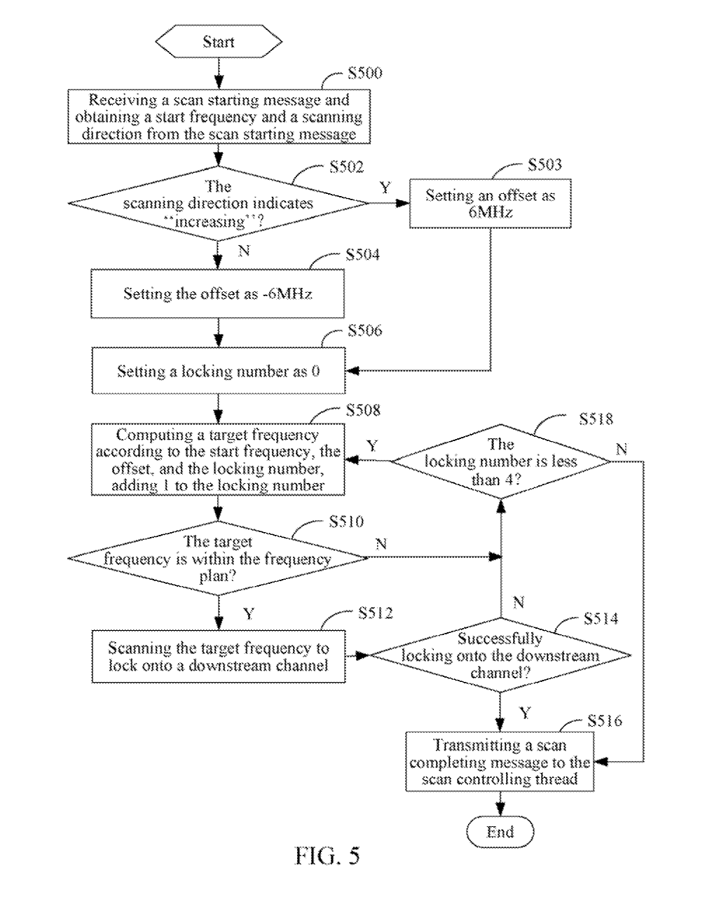

In one embodiment, the scan controlling module 130 includes a computing module 132, a controlling module 134, and a determining module 136. Each channel locking thread 150, 160, 170, 180 includes a setting module 152, a communicating module 154, and a locking module 156, although only modules of the channel locking thread 150 are shown in FIG. 1 for simplicity. Those modules may include one or more computerized instructions stored in the storage system 110 and executed by the at least one processor 100. Function description of those modules is shown in FIG. 4 and FIG. 5.

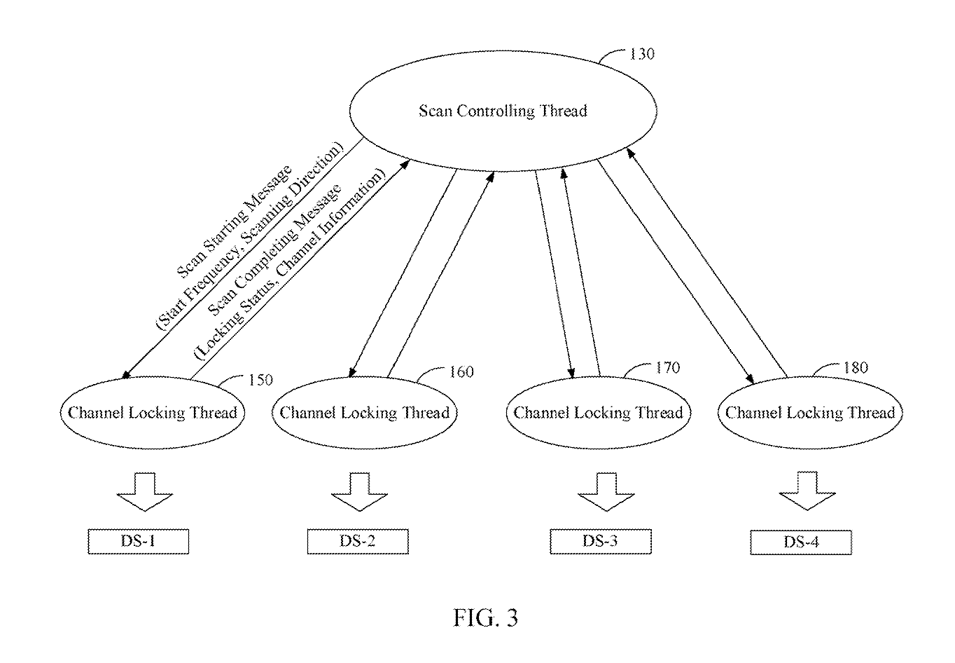

FIG. 3 is a schematic diagram of communication between the scan controlling thread 130 and the locking thread group 140 of FIG. 1. The scan controlling thread 130 transmits four scan starting messages respectively to the channel locking threads 150, 160, 170, 180, although only a scan starting message transmitted to the channel locking thread 150 is shown is FIG. 3 for simplicity. Detailed description of the scan controlling thread 130 is shown in FIG. 4.

Each scan starting message respectively transmitted to each channel locking thread includes one start frequency and one scan direction corresponding to one frequency segment distributed to the channel locking thread. For example, the scan starting message transmitted to the channel locking thread 150 includes the start frequency and the scan direction corresponding to frequency segment DS-1. The scan starting message transmitted to the channel locking thread 160 includes the start frequency and the scan direction corresponding to frequency segment DS-2.

Each of the channel locking threads 150, 160, 170, 180 receives one corresponding scan starting message from the scan controlling thread 130, and scans the corresponding frequency segment to lock onto a downstream channel according to the start frequency and the scan direction of the scan starting message. Each of the channel locking threads 150, 160, 170, 180 transmits the scan completing message to the scan controlling thread 130 when the scanning of the frequency segment completes, although only the scan completing message transmitted by the channel locking thread 150 is shown in FIG. 3 for simplicity.

In one embodiment, each scan completing message includes a locking status and channel information. The locking status indicates whether the corresponding channel locking thread successfully locks onto a downstream channel or not. If one of the channel locking threads 150, 160, 170, 180 successfully locks onto a downstream channel, the channel information includes information of the locked downstream channel. Detailed descriptions of the channel locking threads 150, 160, 170, 180 are shown in FIG. 5.

FIG. 4 is a flowchart of one embodiment of a channel locking method processed by the scan controlling thread 130 of FIG. 1 and FIG. 3. The method may be embodied in the wideband cable modem 10, and is executed by the functional modules such as those of FIG. 1.

In block S402, the computing module 132 obtains a central frequency from the central frequency list 112, and in block S404, computes a start frequency and a scanning direction of each of the frequency segments according to the central frequency of the corresponding frequency range, and sets a message number as 0. The message number indicates the number of the scan completing messages received from the channel locking threads 150, 160, 170, 180 by the scan controlling thread 130.

In one embodiment, the computing module 132 computes the start frequencies and the scanning directions according to that shown in FIG. 2. For example, the obtained central frequency is 138 MHz. The start frequency of the channel locking thread 150 equals 138−3−(7*6) MHz, namely 93 MHz, and the corresponding scanning direction is “increasing”. The start frequency of the channel locking thread 160 equals 138−3 MHz, namely 135 MHz, and the corresponding scanning direction is “decreasing”. The start frequency of the channel locking thread 170 equals 138+3 MHz, namely 141 MHz, and the corresponding scanning direction is “increasing”. The start frequency of the channel locking thread 180 equals 138+3+(7*6) MHz, namely 183 MHz, and the corresponding scanning direction is “decreasing”.

In block S406, the controlling module 134 transmits scan starting messages respectively to the channel locking threads 150, 160, 170, 180. The scan starting messages include the corresponding start frequencies and the scanning directions. Each of the channel locking threads 150, 160, 170, 180 scans the corresponding frequency segment to lock onto a downstream channel after receiving the scan starting message from the scan controlling thread 130 and transmits a scan completing messages including a locking status and channel information to the scan controlling thread 130. In block S408, the controlling module receives the scan completing message from one of the channel locking threads 150, 160, 170, 180, here taking the channel locking thread 150 for example.

In block S410, the determining module 136 determines if the channel locking thread 150 successfully locks onto a downstream channel according to the locking status of the scan completing message. If the channel locking thread 150 unsuccessfully locks onto a downstream channel, then in block S412, the determining module 136 adds 1 to the message number, and in block S414, determines if the message number is less than 4 to determine if the scan controlling thread 130 has received the scan completing message from each of the channel locking threads 150, 160, 170, 180.

If the message number is less than 4, the controlling module 134 continuously receives the scan completing messages from the channel locking threads 160, 170, 180. That the message number is not less than 4 indicates that the scan controlling thread 130 receives the scan completing message from each of the channel locking threads 150, 160, 170, 180, and all of the channel locking threads 150, 160, 170, 180 unsuccessfully lock onto a downstream channel.

If the message number is not less than 4, then in block S402-S414, the scan controlling thread 130 periodically processes a next central frequency of a next frequency range from the central frequency list 112 and controls the channel locking threads 150, 160, 170, 180 to scan a next plurality of frequency segments of the next frequency range to lock onto a downstream channel according to the next central frequency until all the central frequencies are processed or any of the channel locking threads 150, 160, 170, 180 successfully locks onto a downstream channel.

FIG. 5 is a flowchart of one embodiment of a channel locking method processed by the channel locking threads 150, 160, 170, 180 of FIG. 1 and FIG. 3, here taking the channel locking thread 150 for example. The method may be embodied in the wideband cable modem 10, and is executed by the functional modules such as those of FIG. 1.

In block S500, the communicating module 154 receives a scan starting message from the scan controlling thread 130 and retrieves a start frequency and a scanning direction from the scan starting message. In block S502, the setting module 152 determines if the scanning direction is “increasing”. If the scanning direction is “increasing”, then in block S503, the setting module sets an offset as 6 MHz according to the frequency plan of the wideband cable modem 10. If the scanning direction is “decreasing”, then in block S504, the setting module sets the offset as −6 MHz. In block S506, the setting module sets a locking number as 0.

In block S508, the locking module 156 computes a target frequency according to the start frequency, the offset, and the locking number, and adds 1 to the locking number. In block S510, the locking module 156 determines if the target frequency is within the frequency plan of the wideband cable modem 10. If the target frequency is within the frequency plan, then in block S512, the locking module 156 scans the target frequency to lock onto a downstream channel. In block S514, the locking module 156 determines if the downstream channel is successfully locked.

If the downstream channel is successfully locked, then in block S516, the communication module 154 transmits a scan completing message to the scan controlling thread 130. A locking status of the scan completing message indicates that the downstream channel is successfully locked and channel information of the scan completing message includes information on the target frequency.

If the target frequency is not within the frequency plan, or if the downstream channel is unsuccessfully locked by scanning the target frequency, then in block S518, the locking module 156 determines if the locking number is less than a preset number. The preset number is the same as the number of frequencies in a frequency segment, such as 4. If the locking number is less than 4, then in block S508 to S514, the locking module 156 re-computes and re-scans a next target frequency to lock onto a downstream channel.

If the locking number is not less than 4, then in block S516, the communication module 154 transmits a scan completing message to the scan controlling thread 130. A locking status of the scan completing message indicates the downstream channel is unsuccessfully locked. As such, the scan controlling thread 130 can determine if the channel locking thread 150 successfully locks onto a downstream channel according to the scan completing message.

The wideband cable modem 10 of the present disclosure establishes a plurality of the channel locking threads to synchronously scan a plurality of the frequency segments, which decreases time cost to lock onto a downstream channel of the wide cable modem 10. Therefore, the provisioning of the wideband cable modem 10 is expedited and user satisfaction is improved.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A wideband cable modem comprising a processor, a storage system, a plurality of tuners, and one or more programs, wherein the one or more programs are stored in the storage system and operable to be executed by the processor, the wideband cable modem further comprising:
a central frequency list stored in the storage system and comprising one or more central frequencies corresponding to one or more frequency ranges of frequency plan of the wideband cable modem, each frequency range comprising a maximum frequency and a minimum frequency, wherein an average of the maximum frequency and the minimum frequency of each frequency range is equal to the corresponding central frequency, and each frequency range is divided into a plurality of frequency segments;
a plurality of channel locking threads operable to control the plurality of tuners to scan the plurality of frequency segments of the frequency ranges to lock onto a downstream channel of the wideband cable modem; and
a scan controlling thread operable to retrieve one of the central frequencies corresponding to one of the frequency ranges from the central frequency list, to control the plurality of channel locking threads to synchronously scan the plurality of frequency segments of the corresponding one of the frequency ranges to lock onto a downstream channel according to the retrieved central frequency;
wherein the processor is operable to process the channel locking threads and the scan controlling thread.

2. The wideband cable modem as claimed in claim 1, wherein the scan controlling thread is further operable to retrieve a next central frequency corresponding to a next frequency range from the central frequency list, and to control the plurality of the channel locking threads to synchronously scan a plurality of frequency segments of the next frequency range to lock onto a downstream channel according to the next central frequency upon the condition that a downstream channel is unsuccessfully locked according to the retrieved central frequency.

3. The wideband cable modem as claimed in claim 1, wherein the scan controlling thread comprises:
a computing module operable to compute a start frequency and a scanning direction of each of the plurality of frequency segments according to the retrieved central frequency;
a controlling module operable to transmit a plurality of scan starting messages each comprising the corresponding start frequency and the corresponding scanning direction to the plurality of corresponding channel locking threads respectively, and to receive a plurality of scan completing messages each comprising a locking status and channel information from the plurality of channel locking threads; and
a determining module operable to determine if a downstream channel is successfully locked according to the locking status of each of the scan completing messages, and to obtain information on the downstream channel according to the corresponding channel information of the locking status which indicates the downstream channel is successfully locked.

4. The wideband cable modem as claimed in claim 3, wherein each of the channel locking threads comprises:
a communicating module operable to receive one of the scan starting messages from the scan controlling thread and obtain the start frequency and the scanning direction from the received scan starting message;
a setting module operable to set an offset according to the scanning direction and set a locking number as 0; and
a locking module operable to compute a target frequency according to the start frequency, the offset, and the locking number, to add 1 to the locking number, and to scan the target frequency to lock onto a downstream channel if the target frequency is within the frequency plan of the wideband cable modem and the locking number is less than a preset number;
wherein the communicating module is further operable to transmit one scan completing message with the locking status indicating that a downstream channel is successfully locked and channel information being information on the target frequency to the scan controlling thread if the downstream channel is successfully locked.

5. The wideband cable modem as claimed in claim 4, wherein the communicating module is further operable to transmit one scan completing message with the locking status indicating that a downstream channel is unsuccessfully locked to the scan controlling thread if the locking number is not less than the preset number and if the downstream channel is unsuccessfully locked.

6. A channel locking method of a wideband cable modem, the wideband cable modem comprising a processor, a storage system, and a plurality of tuners, the method comprising:
storing a central frequency list in the storage system, the central frequency list comprising one or more central frequencies corresponding to one or more frequency ranges of frequency plan of the wideband cable modem, each frequency range comprising a maximum frequency and a minimum frequency, wherein an average of the maximum frequency and the minimum frequency of each frequency range is equal to the corresponding central frequency, and each frequency range is divided into a plurality of frequency segments;
a scan controlling thread retrieving one of the central frequencies of the corresponding frequency range from the central frequency list;
the scan controlling thread controlling each of a plurality of channel locking threads to synchronously scan each of the frequency segments of the corresponding frequency range to lock onto a downstream channel of the wideband cable modem according to the retrieved central frequency;
each of the channel locking threads controlling each of the tuners to scan each of the frequency segments to lock onto a downstream channel;
the scan controlling thread determining if a downstream channel is successfully locked; and
the scan controlling thread retrieving a next central frequency corresponding to a next frequency range from the central frequency list and controlling the plurality of the channel locking threads to synchronously scan a plurality of frequency segments of the next frequency range if the downstream channel is unsuccessfully locked.

7. The method as claimed in claim 6, wherein the scan controlling thread controlling the plurality of the channel locking threads to lock onto a downstream channel according to the retrieved central frequency comprises:
computing a start frequency and a scanning direction of each of the frequency segments according to the retrieved central frequency;
respectively transmitting a plurality of scan starting messages each comprising the start frequency and the scanning direction of each of the frequency segments to the plurality of corresponding channel locking threads;
receiving a plurality of scan completing messages each comprising a locking status and channel information from the plurality of channel locking threads;
determining if a downstream channel is successfully locked according to each locking status of each of the scan completing messages; and
obtaining information on the downstream channel according to the channel information of the locking status which indicates the downstream channel is successfully locked.

8. The method as claimed in claim 7, wherein each of the channel locking threads controlling the corresponding tuner to scan each of the frequency segments to lock onto a downstream channel comprises:
receiving the corresponding scan starting message from the scan controlling thread and obtaining the start frequency and the scanning direction from the received scan starting message;
setting an offset according to the scanning direction and setting a locking number as 0;
computing a target frequency according to the start frequency, the offset, and the locking number;
adding 1 to the locking number;
determining if the target frequency is within the frequency plan of the wideband cable modem;
scanning the target frequency to lock onto a downstream channel if the target frequency is within the frequency plan of the wideband cable modem;
determining if a downstream channel is successfully locked; and
transmitting one scan completing messages with a locking status indicating that a downstream channel is successfully locked and channel information being information on the target frequency to the scan controlling thread if a downstream channel is successfully locked.

9. The method as claimed in claim 8, wherein each of the channel locking threads controlling the corresponding tuner to scan each of the frequency segments to lock onto a downstream channel further comprises:
determining if the locking number is less than a preset number if the downstream channel is unsuccessfully locked; and
transmitting one scan completing message with the locking status indicating the downstream channel is unsuccessfully locked to the scan controlling thread if the locking number is not less than the preset number.

10. The method as claimed in claim 9, wherein each of the channel locking threads controlling the corresponding tuner to scan each of the frequency segments to lock onto a downstream channel further comprises: re-computing a next target frequency according to the start frequency, the offset, and the locking number and re-adding 1 to the locking number if the locking number is less than the preset number.
